(19) United States
(12) Patent Application Publication
(10) Pub. No.: US 2022/0224265 A1
(43) Pub. Date: Jul. 14, 2022

(54) METHOD FOR HEATING A GENERATOR OF A WIND POWER INSTALLATION

(71) Applicant: Wobben Properties GmbH, Aurich (DE)

(72) Inventors: Stephan Jöckel, Kleinniedesheim (DE); Christian Heyen, Aurich (DE); Tobias Muik, Bensheim (DE); Wojciech Giengiel, Aurich (DE); Stefan Gertjegerdes, Aurich (DE); Menko Bakker, Aurich (DE); Harri Vihriälä, Lilienthal (DE)

(21) Appl. No.: 17/572,441

(22) Filed: Jan. 10, 2022

(30) Foreign Application Priority Data
Jan. 11, 2021 (EP) 21150872.6

(51) Int. Cl. H02P 9/02; H02K 7/18; H02M 5/458; F03D 9/25; F03D 80/60

(52) U.S. Cl. CPC H02P 9/02; H02K 7/183; F03D 80/60; F03D 9/255; H02M 5/4585

(57) ABSTRACT

Provided is a method for heating a generator of a wind power installation during or before starting the installation. The generator is a permanent magnet synchronous generator configured to generate a stator current comprising at least one three-phase current. The installation is configured as a gearless installation and is connected to an electrical supply network for feeding electrical power into the network. The installation comprises a converter, connected to the generator, to control the generator to feed electrical power into the network. The method comprises rotating the rotor with a low rotational speed below a first limit and operating the converter such that the generator generates the stator current and electrical power, and no electrical power is fed into the electrical supply network. At least one portion of the stator current substantially circulates through the generator and the converter to consume power in generator windings to heat the generator.

### BACKGROUND

### Technical Field

The present invention relates to a method for heating a generator of a wind power installation, wherein the generator is a permanent magnet synchronous generator, and the present invention relates to a corresponding wind power installation.

### Description of the Related Art

Wind power installations are known; they generate electrical power from wind by means of a generator. If the wind power installation has not been in operation for a period of time, e.g., because it has been undergoing maintenance or not enough wind was present, it may cool down during this period and moisture may condense on regions that have cooled down. If the wind power installation is then put into operation again, it is necessary firstly to remove the moisture.

This problem has already been described in the published German patent application DE 101 19 625 A1, or corresponding family members. In that case, heating the generator is proposed as a solution. In that case, the wind power installation comprises a separately excited synchronous generator. In that case, for heating purposes, a predefinable excitation current is applied to the generator rotor via the terminals for separate excitation.

In the case of a permanent magnet synchronous generator, however, excitation windings do not exist and therefore it is also not possible for such a generator to be heated in the manner described in the published patent application cited. The permanent magnet synchronous generator also cannot simply be operated with lower power in order firstly to heat it up, since even during operation of the wind power installation with a low power output, the voltages are already at a normal level. The problem of the condensate on the generator is constituted precisely by the fact that normal operating voltage can lead to a short circuit at moist locations.

The European Patent Office searched the following prior art in the priority application with respect to the present application: DE 10 2016 124 135 A1 and EP 2 270 331 A2.

### BRIEF SUMMARY

One or more embodiments are directed to starting a generator that has cooled down, without risking moisture-dictated voltage flashovers.

A method is proposed. The method concerns the heating of a generator of a wind power installation during or before the starting of the wind power installation. In principle, the method for heating before the starting of normal operation of the wind power installation or of the generator is proposed. However, since this method for heating could itself already be regarded as part of the starting process, it may also be referred to as a method during starting.

What is taken as a basis here is a generator that is a permanent magnet synchronous generator, which is usually also abbreviated to PMG. The latter is configured to generate a stator current, wherein the stator current comprises at least one three-phase current. The generator thus comprises at least one three-phase system, but can for example also comprise two three-phase systems galvanically isolated from one another.

Moreover, the wind power installation is configured as a gearless wind power installation and is connected to an electrical supply network, for the purpose of feeding electrical power into the electrical supply network. A gearless wind power installation comprises multi-pole generators having a large diameter. The generator, namely its rotor, is directly coupled to the aerodynamic rotor of the wind power installation and rotates with the same rotational speed. The generator is thus a slowly rotating generator. The rotational speeds usually lie in the range of 7 to 25 rotations per minute (rpm).

The generator accordingly has a large spatial extent. Its air gap diameter can lie in the range of 4 to 10 meters (m). Accordingly, such a generator of a gearless wind power installation also has a large mass which has to be heated and in addition is spatially distributed.

The wind power installation additionally comprises a rotor having rotor blades, which is operable with a variable rotational speed, and a converter system, which is connected to the generator in order to control the generator and which is connected to the electrical supply network in order to feed electrical power that was generated by the generator into the electrical supply network. The converter system may synonymously also be referred to as a converter device or converter arrangement. Insofar as a rotor is mentioned here, this is taken to mean, in principle, the aerodynamic rotor of the wind power installation. For differentiation, the rotor of the generator is referred to as generator rotor. In any case the aerodynamic rotor and thus the wind power installation is operable with a variable rotational speed. Accordingly, the generator is also operable with a variable rotational speed. Consequently, it is also possible to cause the rotor and thus the generator to rotate with a low rotational speed if necessary.

The converter system is thus arranged and connected between the generator and the electrical supply network. Such a converter system is configured in particular such that it is configured as an inverter on the generator side and also on the network side, i.e., toward the electrical supply network. Thus, a generator-side inverter is provided, for controlling the generator, namely for controlling the stator current, and a network-side inverter is provided, for feeding electrical power into the electrical supply network. These two inverters can be coupled via a DC voltage link circuit. The generator-side inverter may also be referred to as an active rectifier since, during normal operation, the generator generates power and outputs the latter by way of its stator current, which is rectified by the generator-side inverter during the control of the generator.

In the case of this set-up, the generator-side inverter thus controls the stator current during operation, which has the effect that a DC current flows into the DC voltage link circuit. The network-side inverter controls the infeed into the electrical supply network, which results in a DC current being drawn from the DC voltage link circuit.

The method now comprises the following steps. The rotor is rotated with a low rotational speed below a first rotational speed limit. Said first rotational speed limit, which will be described even further below, can lie in the range of 2.5 to 4.5 rpm. The rotation is effected with the aid of wind that acts on the rotor blades. For this purpose, the rotor blades are preferably adjusted in each case with their blade angle into a heating blade angle allowing the low rotational speed, which may also be referred to as heating rotational speed, to be attained.

The converter system is then operated such that the generator generates the stator current and electrical power. Moreover, the converter system is operated such that no electrical power is fed into the electrical supply network. In this case, it is proposed that the stator current, at least one portion thereof, substantially circulates through the generator and the converter system in order to consume power at least in stator windings of the generator, in order thereby to heat the generator.

By way of example, the stator current can be rectified by a generator-side inverter and be passed to a DC voltage link circuit. A network-side inverter can conduct the current thus rectified from a positive DC busbar to a negative DC busbar of the DC voltage link circuit, e.g., in the form of a short circuit as a result of the closing of corresponding semiconductor switches. At the negative busbar this current is then available again to the generator-side inverter in order thereby to close the circuit.

It should be taken into consideration here, of course, that the stator current does not circulate in the form of a single DC current. Rather, it is the case that the stator current, which is three-phase at least once here, too, in the generator and at its connecting terminals, is converted in the converter system, namely into a DC current in the example mentioned above. In this respect, the stator current circulates further in a converted form. However, it is also conceivable that the stator current flows only as far as a generator-side inverter or active rectifier and is short-circuited there in the manner of a star or delta connection and thus circulates through said generator-side inverter and thus also circulates through a part of the converter system and thus through the converter system. However, the generator-side inverter will not usually switch a complete star or delta connection, but rather will continue to control the stator current in terms of its level as well.

In accordance with one aspect, it is proposed that the converter system comprises an active rectifier and an inverter. The active rectifier is connected between the generator and a DC voltage link circuit, for controlling the generator and for rectifying the stator current into a DC current for feeding into the DC voltage link circuit, which has a link circuit voltage. The DC voltage link circuit is thus also part of the converter system.

The inverter is connected to the DC voltage link circuit in order to invert energy from the DC voltage link circuit into an AC current for feeding into the electrical supply network. Said inverter may also be referred to as a network-side inverter, and the active rectifier may synonymously be referred to as a generator-side inverter. In order to avoid confusion, however, the term active rectifier is preferably used for the generator-side inverter. The term inverter here denotes the network-side inverter, in principle, unless indicated otherwise.

It is then proposed that the inverter is operated such that the DC voltage link circuit is at least partly short-circuited, or the active rectifier is operated such that phases of the stator current are short-circuited at least at times. Two possibilities are thereby proposed for causing the stator current to circulate through the converter system, namely either at the active rectifier or at the inverter. At the inverter it is conceivable that the DC voltage link circuit is short-circuited permanently, but of course only for the time of the heating process. The current level can then nevertheless be controlled by the active rectifier. In other words, the short circuit current that can flow here from a positive busbar to the negative busbar of the DC voltage link circuit is dependent on how much DC current the active rectifier provides from the stator current.

It is conceivable in the case of the active rectifier, too, that the latter permanently short-circuits the phases of the stator current, in particular in each case the phases of a three-phase system. However, preference is given to the variant that here for the described short-circuiting, too, the active rectifier controls this by means of a pulse pattern, such that the active rectifier can continue to control the stator current in a targeted manner. Such pulsed short-circuiting may thus be referred to as short-circuiting at times.

Particularly if the active rectifier effects only pulsed short-circuiting, it can simultaneously make available a DC current for the DC voltage link circuit, and the short-circuiting at the inverter can then be combined with the short-circuiting at the active rectifier. This has the advantage in particular that it is not just in the generator that heating takes place and counteracts the condensate there by virtue of the circulating stator current, rather that the converter system, too, can be heated and freed of possible condensate at the corresponding locations, i.e., at the active rectifier and/or at the inverter.

In accordance with one aspect, it is proposed that for heating purposes the generator is controlled by the converter system using a field weakening control in order to control a generator torque below a predetermined first torque limit value, which lies below a rated torque of the generator, wherein the rated torque is greater than the predetermined first torque limit value at least by the factor of 2, in particular at least by the factor of 10. The torque in the case of field weakening is thus significantly lower than the rated torque of the generator. A so-called field weakening is thus applied here. This term originates from the control of a DC motor, in which an armature current and a field current can be set. If the field current is reduced, the torque decreases and the rotational speed increases or, in the case of a generator, the generated current decreases for the same rotational speed.

Even though a permanent magnet synchronous generator is based on a different functional principle, a field weakening can nevertheless be carried out here. In particular, such a synchronous generator can be described by a model in which such a field weakening is possible. It is proposed that in this case the generator torque is reduced at least to such an extent that its magnitude is maximally half that of a short circuit current torque of the generator for the same rotational speed.

Such a field weakening can be implemented in particular by virtue of the fact that, for controlling the generator, the latter is controlled by implementing a so-called d/q control. For this purpose, the generator or the stator current to be controlled is transformed into a rotating reference system in which it can be described in a manner similar to a DC motor or analogously thereto. The magnetic field can then be controlled or set by the d component.

Therefore, it is additionally or alternatively proposed that the generator is controlled by implementing a d/q control that predefines a d component and a q component in a rotating reference system, wherein the d component is used for controlling a magnetic field of the generator, and wherein the d component is selected such that it reduces the magnetic field, in particular such that the d component is set to a negative value. When a permanent magnet synchronous generator is controlled without field weakening, a normal magnetic field arises during steady-state operation in each case in the rotating reference system. The magnetic field is reduced by comparison therewith. In particular, the d component can be set to a negative value for the purpose.

By virtue of the proposed field weakening or reduction of the magnetic field in the d/q control, the rotor of the generator can be rotated with less force. The aerodynamic rotor of the wind power installation can thus be rotated with little torque. What is achieved as a result is that an aerodynamically expedient rotational speed can be rotated without much power being generated and in particular without a high voltage being generated. That can be achieved by virtue of the fact that the stator current circulates through the generator and the converter system with low voltage.

In accordance with one aspect, it is proposed that in a start step, while the rotor is operated with the low rotational speed, a generator voltage is controlled to a low value below a first generator voltage limit value, and/or the DC voltage link circuit is operated such that it has a medium link circuit voltage value that lies below a first and above a second predeterminable link circuit voltage limit value. The starting of the heating process is thus carried out such that firstly a voltage that is as low as possible is applied, i.e., a low generator voltage, or a low link circuit voltage, which is intended to be greater than zero, however, in order that the generator can be driven by the active rectifier. A medium link circuit voltage value is therefore proposed for the link circuit voltage. Said value lies between a first and a second predeterminable link circuit voltage limit value. The first, i.e., upper, link circuit voltage limit value can lie in the range of 40 to 60% and the lower, i.e., second, link circuit voltage limit value can lie in the range of 30 to 40% of a rated voltage of the DC voltage link circuit, i.e., of the link circuit voltage. Thus, said value is still comparatively low, but high enough so that the generator is actually driven for outputting power.

Generator voltage is understood here to mean in particular the voltage at the output of the stator of the generator, which voltage may thus also be referred to as stator voltage.

In accordance with one aspect, a chopper step is proposed. The latter is carried out while the rotor continues to rotate with the low rotational speed. It is pointed out that both here and in the other cases when the rotor rotates or is rotated with low rotational speed, this rotational speed need not necessarily be kept at a constant value. At least slight fluctuations are acceptable.

In said chopper step, a chopper circuit of the DC voltage link circuit is operated to the effect of lowering the link circuit voltage, namely to a low link circuit voltage value below the second predeterminable link circuit voltage limit value, in particular below a third predeterminable link circuit voltage limit value. Said third predeterminable link circuit voltage limit value is less, in particular significantly less, than the second predeterminable link circuit voltage limit value.

In the chopper step, therefore, the link circuit voltage is lowered, possibly even to zero, or almost zero. This is possible once the generator is already in operation and is generating a generator current and has also built up a corresponding generator field. That is thus possible in particular after the start step described above.

In particular, the chopper step is carried out such that the chopper circuit controls a chopper current from the DC voltage link circuit to a chopper resistor in order thereby to dissipate energy from the DC voltage link circuit into the chopper resistor. In this case, the chopper circuit uses a pulse modulation in which a pulse duration alternates with a pulse-free time in a period duration in order to control the chopper current by setting a pulse ratio. The pulse ratio is a ratio of the pulse duration to the period duration. To that end, it is proposed that in the chopper step the pulse ratio is increased in order thereby to decrease the link circuit voltage. In particular, the pulse ratio is increased progressively from 0% to approximately 100%.

In this case, a pulse ratio of 100% corresponds to a permanent switch-on. The link circuit voltage then falls to the voltage established by the chopper current at the chopper resistor and the chopper switch. The generator can then be operated at an operating point with very low voltage.

In accordance with one aspect, a field weakening step is proposed in which the rotor continues to rotate with the low rotational speed, the link circuit voltage is controlled to a zero value that is close to zero, in particular using the chopper circuit, and the generator is controlled by the converter system using a or the field weakening control in order to cause the generator to generate little power, in order to support the control of the link circuit voltage to the zero value close to zero. Thus, the generator is then operated in this state of field weakening by virtue of the fact that it generates some power, but the voltage is very low. This can be achieved by means of the chopper circuit and also by means of the described operation of the generator. What is specifically achieved by the field weakening is that the generator generates little power and therefore the DC voltage link circuit cannot be greatly charged and thus the chopper circuit can keep the link circuit voltage approximately at zero. The zero value differs from zero basically only through negligible effects, such as the forward voltage of a semiconductor switch that controls the chopper current. The zero value may synonymously also be referred to as value close to zero.

In accordance with one aspect, a zero mode step is proposed in which, while the rotor continues to rotate with the low rotational speed, and while the link circuit voltage is controlled to the zero value close to zero, a or the inverter connected to the DC voltage link circuit is switched into a zero mode. The zero mode is defined by the fact that both semiconductor switches of at least one semiconductor switch pair are closed in order thereby to short-circuit the DC voltage link circuit. In the zero mode step, it is furthermore proposed that the wind power installation is operated in the zero mode in order to heat at least the generator.

A zero mode may synonymously also be described in German as “Zero-Mode.” It basically describes a specific mode of the inverter. The inverter comprises for each phase a semiconductor switch pair which is connected in series and can generate a sinusoidal current of the relevant phase by means of a corresponding pulse modulation. In this case, said current is basically generated at a tap between these two semiconductor switches. For modulation purposes—in a somewhat simplified manner of expression—one semiconductor switch generates a positive half-cycle of a sinusoidal signal by means of modulation and the other semiconductor switch correspondingly generates a negative half-cycle of the sinusoidal signal. In this case, both semiconductor switches are not closed simultaneously.

In the zero mode, however, it is proposed that both semiconductor switches are closed simultaneously, which can also be provided permanently, in any case for the duration of heating. These two semiconductor switches or the semiconductor switch pair thus forms a short circuit for the DC voltage link circuit. The positive busbar is thus short-circuited with the negative busbar. In this respect, this mode may synonymously also be referred to as a short circuit mode.

The inverter, which usually generates a three-phase current for feeding into the electrical supply network, therefore usually comprises three semiconductor switch pairs, namely one respective pair per phase. In the zero mode, all switches of these three pairs could also be closed. However, since comparatively little power is generated in comparison with rated operation, it will normally suffice to close only the semiconductor switches of one pair.

The wind power installation can then be operated permanently in this state in order to heat at least the generator. The installation can be operated until the abovementioned condensate has sufficiently evaporated, or such a state can at least be assumed. Since such a current in the zero mode also generates heat in the inverter and also the active rectifier, the converter system can thus likewise be heated thereby.

In accordance with one aspect, it is proposed that the start step, the chopper step, the field weakening step and the zero mode step are carried out successively in this order. As a result, it is possible to carry out an effective method for heating the generator and also the converter system before starting, i.e., in particular upon wind arising.

In the start step, this heating mode of operation is thus prepared, in which the generator is firstly operated with little power generation. In this case, the link circuit voltage is not yet zero or close to zero, but nevertheless low at a medium level. However, this voltage forms a kind of back electromagnetic force (EMF) for the generator, too, namely for the generator voltage thereof, with the result that not much current can flow, especially since the rotor rotates only slowly.

In the chopper step, the link circuit voltage and thus also the back EMF is gradually reduced. A higher current can now be generated by the generator.

In order to prevent this current from becoming too great, or to cause little power to be generated, the field weakening step is carried out. The generator then generates little power. On account of the low link circuit voltage that is controlled to zero or almost zero, a correspondingly low current can also flow into the DC voltage link circuit. Said current is moreover dissipated via the chopper resistor through the chopper circuit.

In the zero mode step, however, the inverter is driven such that the DC voltage link circuit is short-circuited. It is now no longer necessary for the generated current fed into the DC voltage link circuit to be dissipated via the chopper resistor. However, the switchover into the zero mode, i.e., the short-circuiting of the DC voltage link circuit by means of the inverter, was only able to be carried out once the link circuit voltage had fallen to zero, or close to zero.

It should be noted that in normal operation of the wind power installation, i.e., not in the described method for heating the generator, the link circuit voltage can have a value approximately of 1200 volts (V). Modern semiconductor switches, in particular insulated-gate bipolar transistors (IGBTs), that can be used have forward voltages in the range of approximately 1 V. With two semiconductor switches in series, this therefore results in approximately 2 V. The link circuit voltage must be greater than this value, of course, otherwise no current can flow. In comparison with the abovementioned 1200 V, however, these few volts can be regarded as 0 V. This value of the link circuit voltage is therefore referred to as a zero value or value close to zero. The control of the link circuit voltage to 0 V can thus constitute control to a value of less than 2%, in particular less than 1%, of a nominal link circuit voltage.

Preferably, the chopper step and the field weakening step can be carried out in an overlapping fashion. In other words, the field weakening step can already be begun while the link circuit voltage is still gradually being reduced to zero or the pulse ratio is still rising to 100% in the chopper step.

In accordance with one aspect, at least one feature of the following listing finds application.

As one feature it is proposed that the first rotational speed limit lies in the range of 20 to 50% of a rated rotational speed of the rotor, and thus, i.e., of a rated rotational speed of the wind power installation. Additionally or alternatively, the first rotational speed limit lies in the range of 2.5 to 4.5 rpm, in particular in the range of 3 to 4 rpm. The rotational speed is thus significantly lower than during rated operation of the wind power installation. That also applies to the values mentioned in absolute terms. It should be taken into consideration in this respect that the generator power usually rises more than proportionally with the rotational speed. In the case of these comparatively low rotational speed values, which moreover only form an upper limit for heating operation, power values that are even significantly lower are thus assigned in relation to a rated power. As a result of the described operating mode of field weakening, the generated power is then even lower. As a result, it is possible to ensure operation of the wind power installation which generates only as much power as is required for heating purposes in order to cause the abovementioned condensate to evaporate.

As a further feature it is proposed that the first generator voltage limit value lies in a range of 30% to 70% of a rated generator voltage. In particular it lies in a range of 200 V to 500 V, in particular in a range of 300 V to 400 V. The generator voltage thus lies below this value and a start-up of the generator for heating purposes at a low rotational speed can thus be made possible, in the case of which the generator generates a power, but without generating a dangerously high voltage.

As a further feature it is proposed that the first predeterminable link circuit voltage limit value lies in a range of 40% to 60% of a rated link circuit voltage, and/or in a range of 400 V to 700 V. That thus marks the upper limit for the medium link circuit voltage which can be set at the beginning of the heating process, but which is then reduced. This value, too, ensures a voltage at which the generator can start up, but without generating dangerous voltage.

In accordance with one aspect, it is proposed that the second predeterminable link circuit voltage limit value lies in a range of 30% to 40% of a rated link circuit voltage, and/or in a range of 300 V to 400 V. This marks in particular that value of the link circuit voltage above which the link circuit voltage lies when the generator is put into operation initially in the start step. This start-up, which requires a certain voltage, can be ensured as a result.

Additionally or alternatively, it is proposed that the third predeterminable link circuit voltage limit value lies in a range of 5% to 20% of the rated link circuit voltage, and/or in a range of 50 to 200 V. Said third predeterminable link circuit voltage limit value is an upper value below which the link circuit voltage is lowered in the chopper step and in the field weakening step. This is therefore a very low value which enables voltage endangerment to be precluded and which in particular is also suitable for initiating or at least preparing the zero mode.

Additionally or alternatively, it is proposed that a or the zero value is less than the third predeterminable link circuit voltage limit value, in particular is less than 2%, in particular less than 1% of the rated link circuit voltage, and/or is less than 20 V, in particular less than 10 V. A very low voltage, which is intended to have almost the value zero, in the DC voltage link circuit is proposed here in order that the inverter can switch and maintain a short circuit in said DC voltage link circuit.

In accordance with one aspect, it is proposed that for the purpose of heating the generator, the wind power installation, in particular the converter system, is disconnected from the electrical supply network. In particular, a galvanic isolation by means of a corresponding disconnecting switch is provided here. This prevents voltage levels from the electrical supply network from reaching the converter system, or even as far as the generator, before the condensate has evaporated. It also prevents the specific operating mode for heating, in particular the zero mode of the inverter, from encountering a network voltage. Other steps from among those proposed are also unsuitable for influencing a network voltage.

In addition, this aspect underlines the fact that the method for heating the generator manages without energy from the electrical supply network.

A wind power installation is also proposed. Said wind power installation is prepared for heating a generator of a wind power installation during or before the starting of the wind power installation. For this purpose an installation controller is provided, on which a method for heating is implemented, wherein
the generator is a permanent magnet synchronous generator (PMG) configured to generate a stator current, wherein the stator current comprises at least one three-phase current, and
the wind power installation is configured as a gearless wind power installation and is connected to an electrical supply network, for the purpose of feeding electrical power into the electrical supply network, and the wind power installation comprises:
   a rotor having rotor blades, which is operable with variable rotational speed,
      a converter system,
      which is connected to the generator in order to control the generator and
      which is connected to the electrical supply network in order to feed electrical power that was generated by the generator into the electrical supply network,
   the method comprises
      rotating the rotor with a low rotational speed below a first rotational speed limit
      operating the converter system such that
      the generator generates the stator current and electrical power, and
      no electrical power is fed into the electrical supply network, wherein
      the stator current, at least one portion thereof, substantially circulates through the generator and the converter system in order to consume power at least in stator windings of the generator, in order thereby to heat the generator.

The wind power installation is thus prepared to carry out a method in accordance with any of the embodiments described above. To that end, it additionally comprises the elements described in the method, namely in particular also a chopper circuit, an active rectifier and an inverter, in each case as elements of the converter system.

For the purpose of carrying out the method, the latter can be implemented in the wind power installation, in particular in the installation controller. For this purpose, the installation controller can comprise a corresponding process computer in which the respective method is implemented as a program.

### BRIEF DESCRIPTION OF THE SEVERAL VIEWS OF THE DRAWINGS

The invention is explained in greater detail below by way of example on the basis of embodiments with reference to the accompanying figures.

FIG. 1 shows a wind power installation in a perspective illustration.

FIG. 2 shows a converter system with a generator in a schematic illustration.

FIG. 3 shows a flow diagram for the method for heating the generator.

### DETAILED DESCRIPTION

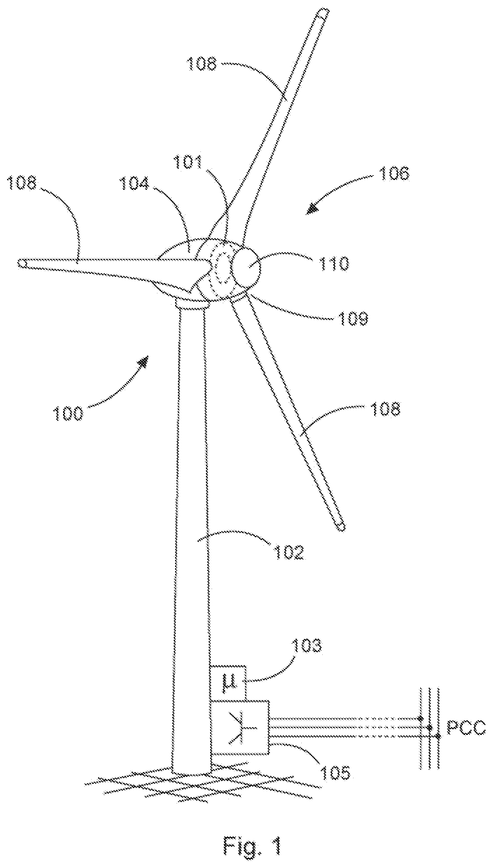

FIG. 1 shows a schematic illustration of a wind power installation according to the invention. The wind power installation 100 comprises a tower 102 and a nacelle 104 on the tower 102. An aerodynamic rotor 106 comprising three rotor blades 108 and a spinner 110 is provided on the nacelle 104. The aerodynamic rotor 106 is caused to effect a rotational movement by the wind during operation of the wind power installation and thus also rotates an electrodynamic rotor of a generator, which is coupled to the aerodynamic rotor 106 directly or indirectly. The electrical generator is arranged in the nacelle 104 and generates electrical energy. The pitch angles of the rotor blades 108 can be varied by pitch motors on the rotor blade roots 109 of the respective rotor blades 108.

In this case, the wind power installation 100 comprises an electrical generator 101, indicated in the nacelle 104. Electrical power can be generated by means of the generator 101. For feeding in electrical power, a converter system 105 is provided, which comprises an inverter in order to feed into the electrical supply network at the network connection point PCC, and which comprises an active rectifier connected to the generator 101. It is thus possible to generate a three-phase infeed current and/or a three-phase infeed voltage according to amplitude, frequency and phase, for infeed at a network connection point PCC. That can be effected directly or else jointly with further wind power installations in a wind farm. An installation controller 103 is provided for controlling the wind power installation 100 and also the converter system 105. The installation controller 103 can also acquire predefined values from an external source, in particular from a central farm computer.

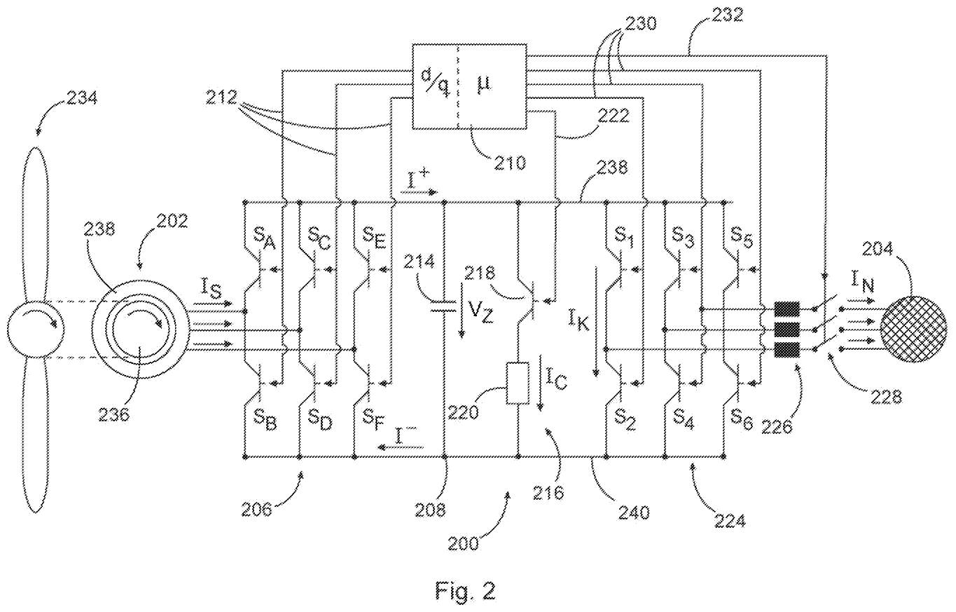

FIG. 2 shows a converter system 200 arranged between a synchronous generator 202 and an electrical supply network 204. The converter system 200 comprises an active rectifier 206 connected to the synchronous generator 202 in order to control a three-phase stator current I_{S}. For the sake of simplicity, the stator current I_{S} is depicted only on one phase, but it encompasses all three phases. A current arrow pointing from the synchronous generator 202 in the direction of the active rectifier 206 is depicted in each case. This direction should be understood merely symbolically, however, since the stator current is an AC current, of course. The arrow direction indicates the power flow direction since the synchronous generator 202 is intended to operate as a generator and to output power. In the described method for heating the generator, too, the latter outputs power.

The active rectifier 206 can convert said three-phase stator current I_{S} into a DC current and input it into the DC voltage link circuit 208. The resulting DC current is illustrated here as I⁺ and I⁻. In this case, the active rectifier 206 is illustrated merely schematically by six semiconductor switches S_{A} to S_{F}. A complete construction of such an active rectifier also includes, of course, corresponding diodes in parallel with the semiconductor switches, which have been omitted here for the sake of better clarity. The functioning of such an active rectifier, which may also be referred to as a generator-side inverter, is known to a person skilled in the art. The symbols of the semiconductor switches are also greatly simplified.

A drive unit 210 is provided for driving purposes, which drive unit can be part of an installation controller. The drive unit 210 can drive each of the semiconductor switches S_{A} to S_{F}. As a result, the stator current I_{S} can be controlled and the generator 202 can thus be controlled electrically. For the purpose of driving the generator 202, provision is made for using a d/q control. That is indicated by the symbol d/q in the drive unit 210. Corresponding control lines 212 correspondingly run from the drive unit 210 to the semiconductor switches S_{A to} S_{F}.

The DC voltage link circuit 208 comprises a link circuit capacitor 214, and the DC voltage link circuit 208 and thus the link circuit capacitor 214 have a link circuit voltage V_{Z}. In the DC voltage link circuit 208, a chopper circuit 216 is additionally provided, in parallel with the link circuit capacitor 214. The chopper circuit 216 comprises a chopper switch 218 and a chopper resistor 220. The chopper switch 218 is likewise configured as a semiconductor switch and can be driven by the drive unit 210 via the chopper control line 222.

The chopper circuit 216 serves to dissipate power from the DC voltage link circuit 208, if that is necessary. During normal operation that is necessary if the link circuit voltage V_{Z} becomes too great, namely becomes greater than its rated voltage. The chopper switch 218 can then be driven such that it switches in a pulsed manner in order thereby to control a current through the chopper resistor 220. The chopper resistor 220 usually has a comparatively small resistance, with the result that a high current can flow depending on the driving of the chopper switch 218. Said current is then converted into heat in the chopper resistor 220.

Furthermore, an inverter 224 is provided, which in principle can be constructed like the active rectifier 206. In particular, it comprises six semiconductor switches S₁ to S₆. Two semiconductor switches in each case form a semiconductor switch pair, namely S₁ and S₂, S₃ and S₄ and also S₅ and S₆. In the case of the inverter 224, too, only a simplified structure is shown, with greatly simplified symbols for the semiconductor switches S₁ to S₆ and also with the omission of diodes correspondingly connected in parallel.

During normal operation of the wind power installation or of the converter system 200, the inverter 224 generates a three-phase AC current I_{N} by means of the semiconductor switches S₁ to S₆. Said current is thus generated as a three-phase sinusoidal AC current I_{N}, for which purpose the three-phase inductor 226 indicated is also required. Said three-phase AC current I_{N} then flows via a network disconnecting switch 228 into the symbolically indicated electrical supply network 204. The network disconnecting switch 228 is closed, of course, in this normal case. The AC current I_{N} is indicated by three current arrows in the direction of the electrical supply network 204, but this current is an AC current, of course, and power could also flow from the electrical supply network 204 to the inverter 224.

For the purpose of driving the six semiconductor switches S₁ to S₆, inverter control lines 230 are provided, via which the drive unit 210 can drive the inverter 224. The drive unit 210 can also drive the network disconnecting switch 228, namely via the disconnecting switch control line 232.

In a proposed method for heating the generator 202, therefore, the symbolically indicated rotor 234 is rotated with a slow rotational speed by the wind and a generator rotor 236 of the synchronous generator 202 thus rotates with the same rotational speed in the same direction. The synchronous generator 202 is configured here symbolically as internal rotor and thus has its stator 238 on the exterior.

In any case it is proposed for the method that at the beginning of the method for heating the generator 202, the link circuit voltage V_{Z} has a medium voltage range, e.g., 400 V if it lies between 1000 and 1200 V during normal operation. The network disconnecting switch 228 is open for this entire method, as is also illustrated in FIG. 2. At the beginning, the inverter 224 is inactive. A voltage is then established very rapidly in the DC voltage link circuit 208 and thus across the link circuit capacitor 214, which specifically is charged by the generator in this case.

The link circuit voltage is then reduced, however, as a result of the driving of the chopper circuit or the chopper switch 218 thereof. The link circuit voltage V_{Z} then decreases from the initially medium voltage range into a low voltage range down to close to zero. The generator 206 is then operated with field weakening using a d/q control. The magnetic field of the synchronous generator, at least in the model used to control the synchronous generator, is then reduced to a very great extent. The synchronous generator 202 then generates little current, which at that moment is still generated as three-phase stator current I_{S} and is converted into the DC current I⁺ or I⁻. At this moment a chopper current I_{C} generated by a pulse modulation method then flows through the chopper resistor 220 and through the chopper switch 218. Said chopper current I_{C} is therefore a pulsed current having an average value greater than the DC current I⁺ or I⁻, since said DC current is dissipated via said chopper circuit and energy is additionally dissipated from the link circuit capacitor 214.

If the link circuit voltage V_{Z} is then zero or almost zero, the inverter 224 is driven such that it carries out a short circuit between the positive busbar 238 and the negative busbar 240. For this purpose, it can simultaneously close and leave closed for example the two semiconductor switches S₁ and S₂ of the corresponding semiconductor switch pair that they form. A short circuit current I_{K} then flows. The driving of the chopper circuit 216 can then be ended, such that the chopper switch 218 remains open.

The heating of the generator 202 can then be carried out in this situation, wherein the active rectifier 206 and the inverter 224 will also absorb some heat. Ideally or as a simplification, a steady state is then established in which the stator current I_{S} is rectified and results in the positive DC current I⁺, which flows into the positive busbar 238. From there said current flows further as I_{K} through the two semiconductor switches S₁ and S₂ of the inverter 224 in the example shown. The short circuit current I_{K} then corresponds to the positive DC current I⁺ in terms of its magnitude. The current then correspondingly flows to the negative busbar 240 and then forms the negative DC current I⁻. The latter in this case however is also a result of the control of the stator current I_{S} by the active rectifier 206. In this respect, a current circulation is formed for the stator current I_{S}, wherein the stator current in this case partly appears as DC current.

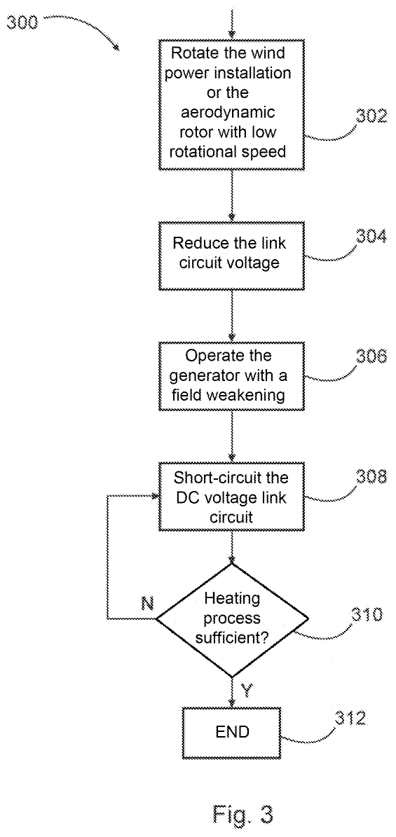

FIG. 3 illustrates the sequence of the proposed method for heating the generator. In the flow diagram 300 in FIG. 3, firstly the start step 302 is provided. In the start step 302, the wind power installation or its aerodynamic rotor is rotated with low rotational speed. In this case, the converter system has a medium link circuit voltage, as has been described in association with FIG. 2. The flow diagram and thus the start step 302 can be selected for example if the wind power installation has not been operated for a relatively long time and/or if it has fallen below a limit temperature and/or if a corresponding air humidity or even a condensate has been detected. The start step 302 is followed by the chopper step 304. In the chopper step 304, the link circuit voltage V_{Z} is then slowly reduced and brought as far as possible toward zero or close to zero. That is effected as elucidated in FIG. 2, by means of a chopper circuit such as the chopper circuit 216.

The field weakening step 306 then follows, although it can also overlap the chopper step 304. In the field weakening step 306, the generator is operated with a field weakening, such that it generates comparatively little power and thus comparatively little current. As a result, bringing the link circuit voltage to zero or close to zero can then be accomplished as well. The zero mode can then commence.

The zero mode is illustrated in the zero mode step 308. In the latter, the DC voltage link circuit is short-circuited, namely by means of the inverter. That, too, has been described with reference to FIG. 2. The driving of the chopper circuit can then be ended and the method for heating can basically be operated for a relatively long time in the state that was established in the zero mode step 308.

In order to illustrate this relatively long operation, the zero mode step 308 is followed by an interrogation 310. Said interrogation 310 involves checking whether the heating process was sufficient. For this purpose, a time can be set from experience, or a temperature can be monitored, or the moisture can be monitored directly, to mention some examples. These criteria can also be combined.

In other words, if a termination condition has not yet been reached, then the interrogation 310 returns to the zero mode step 308. That is merely intended to mean, however, that operation is continued. That is to say that the short-circuiting of the DC voltage link circuit by the inverter is not initialized again, but rather maintained.

However, if the interrogation 310 reveals that the heating process can be ended, i.e., the interrogation is positive, the method is ended, which is symbolized by the end step 312.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for heating a generator of a wind power installation during or before starting the wind power installation, wherein:
the generator is a permanent magnet synchronous generator configured to generate a stator current, wherein the stator current includes at least one three-phase current,
the wind power installation is configured as a gearless wind power installation and is coupled to an electrical supply network for feeding electrical power into the electrical supply network, and
the wind power installation includes:
a rotor having a plurality of rotor blades operable at a variable rotational speed; and
a converter coupled to the generator and configured to control the generator, wherein the converter is coupled to the electrical supply network for feeding the electrical power generated by the generator into the electrical supply network, and
the method comprises:
rotating the rotor using a first rotational speed that is below a first rotational speed limit;
operating the converter to cause the generator to generate the stator current and the electrical power;
operating the converter to refrain from feeding the electrical power into the electrical supply network;
circulating at least a portion of the stator current through the generator and the converter; and
consuming power at least in stator windings of the generator to heat the generator.

2. The method as claimed in claim 1, wherein the converter includes:
an active rectifier coupled between the generator and a DC voltage link circuit, the active rectifier being configured to control the generator and rectify the stator current into a DC current for feeding into the DC voltage link circuit, wherein the DC voltage link circuit has a link circuit voltage; and
an inverter coupled to the DC voltage link circuit and configured to invert energy from the DC voltage link circuit into an AC current for feeding into the electrical supply network, wherein:
the inverter is operated such that the DC voltage link circuit is short-circuited at specific time periods, and/or
the active rectifier is operated such that phases of the stator current are short-circuited at specific time periods.

3. The method as claimed in claim 1, comprising:
controlling, by the converter, the generator using field weakening control for heating the generator, wherein controlling the generator includes controlling a generator torque below a first torque limit value, wherein the first torque limit value is less than a rated torque of the generator, wherein the rated torque is greater than the first torque limit value at least by the factor of 2, and/or
controlling the generator by implementing a d/q control, wherein the d/q control sets a d component and a q component in a rotating reference system, wherein the d component is used for controlling a magnetic field of the generator, and the d component is selected such that the d component reduces the magnetic field.

4. The method as claimed in claim 3, wherein the d component is set to a negative value.

5. The method as claimed in claim 1, comprising:
in response to the rotor being operated with the first rotational speed, setting a generator voltage to a first value that is lower than a first generator voltage limit value, and/or
in response to the rotor being operated with the first rotational speed, operating a DC voltage link circuit to have a first link circuit voltage value that is lower than a first link circuit voltage limit value and greater than a second link circuit voltage limit value.

6. The method as claimed in claim 1, comprising:
in response to the rotor continuing to rotate with the first rotational speed, operating a chopper circuit of a DC voltage link circuit and lowering a link circuit voltage to a first link circuit voltage value that is less than a second link circuit voltage limit value.

7. The method as claimed in claim 6, wherein the chopper circuit controls a chopper current from the DC voltage link circuit to a chopper resistor, wherein the chopper circuit uses pulse modulation, in which a pulse duration alternates with a pulse-free time in a period duration, to control the chopper current by setting a pulse ratio, wherein the pulse ratio specifies a ratio of the pulse duration to the period duration, and wherein the pulse ratio is increased to decrease the link circuit voltage.

8. The method as claimed in claim 7, wherein the pulse ratio is increased progressively from 0% to 100%.

9. The method as claimed in claim 1, comprising:
in response to the rotor continuing to rotate with the first rotational speed, controlling a link circuit voltage to a zero value using a chopper circuit; and
controlling, by the converter, the generator using a field weakening control to cause the generator to generate less power and support controlling the link circuit voltage to the zero value.

10. The method as claimed in claim 1, comprising:
in response to the rotor continuing to rotate with the first rotational speed and a link circuit voltage being controlled to a zero value, switching an inverter coupled to a DC voltage link circuit to a zero mode, wherein in the zero mode, both semiconductor switches of at least one semiconductor switch pair are closed to short-circuit the DC voltage link circuit; and
in response to the rotor continuing to rotate with the first rotational speed and the link circuit voltage being controlled to the zero value, operating the wind power installation in the zero mode to heat at least the generator.

11. The method as claimed in claim 4, wherein at least one of:
the first rotational speed limit is 20 to 50% of a rated rotational speed of the rotor,
the first rotational speed limit is 2.5 to 4.5 rotations per minute (rpm),
the first rotational speed limit is 3 to 4 rpm,
the first generator voltage limit value is 30% to 70% of a rated generator voltage,
the first generator voltage limit value is 200 V to 500 V,
the first generator voltage limit value is 300 V to 400 V,
the first link circuit voltage limit value is 40% to 60% of a rated link circuit voltage,
the first link circuit voltage limit value is 400 V to 700 V,
the second link circuit voltage limit value is 30% to 40% of the rated link circuit voltage,
the second link circuit voltage limit value is 300 V to 400 V,
a third link circuit voltage limit value is 5% to 20% of the rated link circuit voltage,
the third link circuit voltage limit value is 50 V to 200 V,
a zero value is less than the third link circuit voltage limit value,
the zero value is less than 2% of the rated link circuit voltage,
the zero value is less than 1% of the rated link circuit voltage,
the zero value is less than 20 V, or
the zero value is less than 10 V.

12. The method as claimed in claim 1, wherein for heating the generator, the wind power installation or the converter is disconnected from the electrical supply network.

13. A wind power installation configured to heat a generator of the wind power installation during or before starting wind power installation, comprising:
an installation controller configured to control heating the wind power installation;
a permanent magnet synchronous generator configured to generate a stator current, wherein the stator current includes at least one three-phase current, wherein the wind power installation is a gearless wind power installation and is coupled to an electrical supply network, for feeding electrical power into the electrical supply network;
a rotor having a plurality of rotor blades operable at a variable rotational speed; and
a converter coupled to the generator and configured to control the generator, wherein the converter is coupled to the electrical supply network and configured to feed the electrical power, generated by the generator, into the electrical supply network,
wherein the controller is configured to:
cause the rotor to rotate with a first rotational speed below a first rotational speed limit; and
operate the converter such that the generator generates the stator current and the electrical power, and no electrical power is fed into the electrical supply network, wherein at least a portion of the stator current circulates through the generator and the converter to consume power at least in stator windings of the generator to heat the generator.
